(19) United States
(12) Patent Application Publication
(10) Pub. No.: US 2007/0050494 A1
(43) Pub. Date: Mar. 1, 2007

(54) Automatic program guide for windows media streams

(76) Inventors: Richard Mavrogeanes, Wallingford, CT (US); John M. Senior, Cheshire, CT (US); Bruce Webber, Woodbridge, CT (US)

Correspondence Address: ALIX YALE & RISTAS LLP, 750 MAIN STREET, SUITE 1400, HARTFORD, CT, 06103, US

(21) Appl. No.: 11/511,590

(22) Filed: Aug. 29, 2006

Related U.S. Application Data
(60) Provisional application No. 60/712,225, filed on Aug. 29, 2005.

(51) Int. Cl. G06F 15/173

(52) U.S. Cl. 709/223

(57) ABSTRACT

An automatic program guide for media streams automates the identification of streaming media without human intervention for both a unicast and a multicast case.

### CROSS-REFERENCE TO RELATED APPLICATION

This application claims the priority of U.S. Provisional Patent Application No. 60/712,225 filed on Aug. 29, 2005.

### BACKGROUND OF THE INVENTION

The delivery of streaming media in a digital network requires that potential viewers know how to access the stream. For conventional Internet delivery, this is usually accomplished via a “hyperlink” in a web page to the streaming media. This normally requires manual intervention to “post” the reference URL, or can be automated using various database technologies.

The invention described here automates the identification of streaming media without human intervention.

### DETAILED DESCRIPTION OF THE PREFERRED EMBODIMENT

There are two cases where automation is desired, multicast and unicast.

In the multicast case, a source of streaming media is configured to generate a periodic announcement and deliver it on a well-known IP address, typically via multicast on address 224.2.127.254 and port 9875. Media players “listen” to this address and receive the periodic announcements and construct a viewing guide using the information contained in the announcements.

In the unicast case, a source of streaming media is configured to generate a periodic announcement and deliver it to a specific IP address of a single server that “listens” for the announcements. The server then constructs a viewing guide using the information contained in the announcements.

What is claimed:

1. A source of live streaming media, specifically in the Windows Media format, that generates periodic announcements containing information on how to play the media and sends the announcements via IP multicast.

2. A source of live streaming media, specifically in the Windows Media format, that generates announcements containing information on how to play the media, and sends the announcements via IP unicast to a specified destination.

3. A receiver of periodic announcements that contain information on how to play streaming media, specifically, Windows Media format, such that the receiver can display program guide information in a web page.
